(19) United States
(12) Patent Application Publication
(10) Pub. No.: US 2008/0000540 A1
(43) Pub. Date: Jan. 3, 2008

(54) Flexible Hose

(75) Inventor: Andreas SEYLER, Gründau (DE)

Correspondence Address: BUCHANAN, INGERSOLL & ROONEY PC, POST OFFICE BOX 1404, ALEXANDRIA, VA, 22313-1404, US

(73) Assignee: Veritas AG, Gelnhausen (DE)

(21) Appl. No.: 11/791,454

(22) PCT Filed: Apr. 29, 2005
(86) PCT No.: PCT/EP05/04682

§ 371 Date: Jul. 13, 2007

(30) Foreign Application Priority Data
Nov. 25, 2004 (DE) 20 2004 018 301.3

(51) Int. Cl. F16L 11/00

(52) U.S. Cl. 138/126; 138/132

(57) ABSTRACT

The invention relates to a flexible hose, preferably a charge air hose, with a wall having at least partly an elastomeric material, in which a pressure support is arranged, which has at least one essentially threadlike or wirelike pressure support element. In order to improve a flexible hose of this nature such that it exhibits a longer service life in comparison to known hoses, provision is made that the pressure support element is movable at least partly with respect to the wall.

### TECHNICAL FIELD

Flexible hose, preferably a charge air hose, with a wall having at least partly an elastomeric material, in which a pressure support is arranged, which has at least one essentially threadlike or wirelike pressure support element.

### BACKGROUND INFORMATION

Flexible hoses of this nature are known from the state of the art and are for example used as so-called charge air hoses in automotive construction. Here, they are preferred for use with internal combustion engines with turbochargers. They are deployed there in a known manner, for example between the air intake and an intercooler or between an intercooler and the turbocharger. Charge air hoses of this nature are dynamically highly stressed constructions. They dampen the relative movements between the vehicle engine and the car body, also including the pressure pulsations caused by the turbocharger. Internally they are stressed with high temperatures up to 250° C. Typical charge air hoses have a wall with a number of layers of elastomeric material. The pressure support is positioned between the layers. The pressure support normally comprises a knitted thread, thus itself forming a layer in the wall of the hose. The elastomeric layers lying in the radial direction of the hose or of the wall before and behind the pressure support are usually joined together between the individual pressure support elements of the pressure support formed by threads of yarn, in order to produce the best possible bond between the layers of the wall of the hose and the pressure support. So far a bond of this nature, as strong as possible, between the layer in the wall and the pressure support has represented a quality feature of a charge air hose.

The high dynamic stresses to which the charge air hoses are subjected however continue to lead to damage in the charge air hoses. Furthermore, due to increasing charge pressures and the further increasing power of internal combustion engines, charge air hoses are subjected to continually increasing stresses.

### SUMMARY

It is therefore the object of the invention to further develop a flexible hose of the type mentioned in the introduction in that in comparison to known hoses it has a longer service life.

The object is solved according to the invention by a flexible hose of the type mentioned in the introduction, in which the pressure support element 5 is embedded in the matrix of the wall 2 and, at least in parts of the pressure support element 5, is movable with respect to the matrix of the wall 2.

It has proven that with flexible hoses, in particular charge air hoses, in which the pressure support is accommodated for movement in the wall of the hose, the service life of the hose can be substantially increased. Through this mobility, on one hand internal friction between the pressure support element and the wall of the hose is produced, wherein already energy is dissipated during the operation of the flexible hose. Already as a consequence of this, the service life can be extended. Simultaneously, this mobility of the pressure support element with respect to the flexible hose facilitates yielding of the pressure support during dynamic stressing so that local pressure spikes can be avoided and a premature failure of the hose prevented.

In an advantageous further development of the invention the pressure support element can be at least partly, preferably completely provided with an anti-adhesion coating. With an anti-adhesion coating of this nature the mobility of the pressure support element in the wall of the flexible hose can be improved.

Here, it can be of advantage if the anti-adhesion coating has a sliding means. Also with a sliding means of this nature the mobility of the pressure support element in the wall can be improved.

Various plastics may be suitable here as the anti-adhesion coating. The economical processing of plastics simplifies the production of the anti-adhesion coating.

Anti-adhesion coatings have proven advantageous which comprise fluoropolymers, preferably fluorothermoplastics or polytetrafluoroethylene (PTFE). With these materials anti-adhesion coatings with very low coefficients of friction can be realised.

With an alternative embodiment the anti-adhesion coating can also comprise wax. Also wax can be processed economically and facilitates low coefficients of friction.

In a further advantageous embodiment the anti-adhesion coating can comprise oil. Also with this, the mobility of the pressure support element in the wall can be improved. Oil can also be used as a lubricant between the pressure support element and the wall. Other lubricants are also conceivable, such as for example graphite or grease.

Also, the anti-adhesion coating can comprise polyolefins. Also with these, economical anti-adhesion coatings can be realised.

In a preferred embodiment is has been found favourable if the pressure support element is embedded in the wall. Through embedding of this nature a defined guidance of the pressure support element in the wall can occur and at the same time the desired mobility can be established.

In an advantageous further development of the invention, the pressure support can comprise a number of pressure support elements. In this way, the strength properties of the flexible hose can be specifically influenced.

Here, it can prove favourable if the pressure support elements contact one another. Just due to the contact of the pressure support elements, they can rub against one another and dissipate energy during the operation of the charge air hose.

A particularly advantageous embodiment of the flexible hose according to the invention can be achieved if the pressure support elements cross one another. In this manner the pressure support is essentially arranged as a type of mesh. This facilitates adequate flexibility of the hose and also the flexible hose can exhibit the desired strength.

Similarly, it can prove advantageous if the pressure support elements are woven together or interlaced. Also as a result, the strength of the pressure support can be improved while retaining the flexibility, because the pressure support elements lie movable against one another.

In an advantageous further development of the invention, the pressure support element can comprise a textile yarn. A textile yarn of this nature is particularly suitable for the endless production of flexible hoses on machines. During the extrusion process of a hose the pressure support can be, for example, knitted onto the hose before a further layer of the hose is applied to the pressure support.

Pressure support elements can be particularly economically formed when they comprise a plastic yarn.

The strength of the flexible hose can be increased if the pressure support elements comprise a metallic wire. This can be used simultaneously to conduct away electrical charges.

Furthermore, the pressure support element can comprise a ceramic material to increase the strength of the flexible hose or of the pressure support.

In an advantageous further development of the invention the wall can be constructed with many layers and the pressure support arranged between two of the layers. This layer composition is in particular suitable for industrial production where first an inner layer is extruded, then the pressure support knitted on and then the outer layer is extruded on.

In an advantageous further development it can also prove favourable if at least one of the layers of the wall comprises elastomeric material. This material can prove to be advantageous in particular with regard to flexibility with simultaneous strength.

Similarly, it can also prove favourable if at least one of the layers of the wall comprises rubber.

Furthermore, it can prove advantageous if the pressure support is arranged between two elastomeric layers.

### BRIEF DESCRIPTION OF THE DRAWINGS

The invention is explained in more detail in the following based on two embodiments.

The following are shown:

FIG. 1 a first embodiment of the invention,

FIG. 2 a second embodiment of the invention and

FIG. 3 a pressure support element in cross-section.

### DETAILED DESCRIPTION

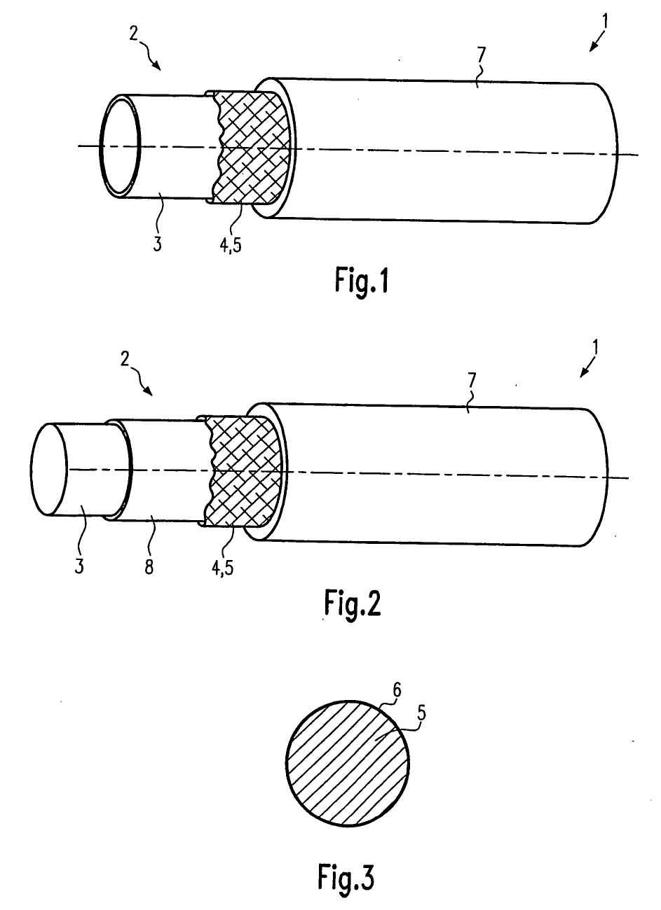

FIG. 1 shows a first embodiment of the invention. The flexible hose 1 is illustrated in FIG. 1 in a manner in which the various constituents of the flexible hose 1 can be recognised. The flexible hose 1 is used as a charge air hose and has a wall 2, comprising three layers. An inner layer 3 comprises a comparatively strong plastic, such as for example a polyolefin. A pressure support 4 is fitted to this inner layer. This pressure support is partly visible in FIG. 1. It comprises a number of pressure support elements 5, which cross one another and are arranged on the inner layer 3 contacting one another. In this respect, after the extrusion of the inner layer 3 the pressure support 4 with its pressure support elements 5 is knitted on so that the pressure support exhibits essentially a mesh-type structure. The pressure support elements 5 here comprise a yarn which is provided with a coating 6. This coating involves a fluoropolymer, preferably polytetrafluoroethylene.

Instead of a yarn also a thread or wire of plastic, for example of a polyolefin, can be used. Similarly, it is conceivable that a metallic wire can be provided. The thread or wire is in each case provided with a coating 6, which either forms the sliding means itself or contains a sliding means. Instead of a fluoropolymer the use of for example wax or oil or a plastic coating, such as for example a polyolefin, is also conceivable. It is also conceivable to use a thread or wire of plastic which completely comprises a sliding material.

On the pressure support an elastomer layer, the outer layer 7, is extruded on, which contains the rubber. Here, the rubber enters the spaces between the pressure support elements and can therefore bond with the layer lying under the pressure support. In this way embedding of the pressure support element or of the pressure support occurs in the wall structure of the flexible hose.

In the following the functional principle of the invention is explained in more detail. Due to the fact that the pressure support elements of the pressure support are provided with a coating, which acts as an anti-adhesion coating, the pressure support elements are movable with respect to the wall of the flexible hose. Due to the anti-adhesion coating a physical or chemical bond between the pressure support elements and the wall matrix of the flexible hose surrounding them as the inner layer and the outer layer 7 should be avoided. Since the pressure support or the pressure support elements are embedded in the wall of the flexible hose, as it were channels are created in which the individual pressure support elements are accommodated for movement in their longitudinal direction. This mobility enables the hose to give when pressure spikes occur in order to reduce the pressure spikes. The service life of the hose can in this way be extended sustainable.

Furthermore, a second embodiment of the invention is described. To avoid repetition however, only the differences to the first embodiment are explained in more detail. The flexible hose according to the second embodiment similarly has an internal layer 3, a pressure support 4 of pressure support elements 5 and an outer layer 7. Additionally, an intermediate layer 8 is provided which similarly comprises an elastomeric material. The elastomeric material similarly comprises rubber. The intermediate layer 8 borders the inner layer 3. In contrast to the first embodiment, the pressure support is now arranged with its pressure support elements between the outer layer 7 and the intermediate layer 8. The pressure support is thus embedded between two elastomeric layers. A hose designed in this way facilitates greater flexibility than the hose according to the first embodiment.

The hose according to the second embodiment can be manufactured, as also the hose according to the first embodiment, using the extrusion method, wherein the pressure support with its pressure support elements is preferably knitted on. Due to the anti-adhesion properties of the pressure support element, the production speed can also be increased so that overall the manufacturing costs of the hose can be reduced. The pressure support elements provided with an anti-adhesion coating slide better within the diversion paths of the knitting machines when manufacturing the flexible hose.

With the second embodiment the outer layer 7 and the intermediate layer 8 are similarly closely bonded or are joined together between the pressure support elements. Since due to the anti-adhesion coating the pressure support elements do not form any physical or chemical joint with the matrix of the outer layer 7 and intermediate layer 8 surrounding them, the pressure support elements or the pressure support are embedded in the matrix, but are however movable with respect to the matrix. The matrix forms channels for the pressure support elements.

1. Flexible hose, preferably a charge air hose, with a wall at least partly comprising elastomeric material, in which a pressure support is arranged, which comprises at least one essentially threadlike or wirelike pressure support element, wherein the pressure support element is embedded in the matrix of the wall and at least in parts of the pressure support element is movable with respect to the matrix of the wall.

2. Flexible hose according to claim 1, wherein the pressure support element is provided at least partly, preferably completely with an anti-adhesion coating.

3. Flexible hose according to claim 1, wherein the anti-adhesion coating comprises a sliding means.

4. Flexible hose according to claim 1, wherein the anti-adhesion coating comprises a plastic.

5. Flexible hose according to claim 1, wherein the anti-adhesion coating comprises fluoropolymers, preferably fluorothermoplastics or PTFE.

6. Flexible hose according to claim 1, wherein a lubricant is provided between the pressure support element and the wall.

7. Flexible hose according to claim 1, wherein the anti-adhesion coating comprises wax.

8. Flexible hose according to claim 1, wherein the anti-adhesion coating comprises oil.

9. Flexible hose according to claim 1, wherein the anti-adhesion coating comprises a polyolefin.

10. Flexible hose according to claim 1, wherein the pressure support element is embedded in the wall.

11. Flexible hose according to claim 1, wherein the pressure support comprises a number of pressure support elements.

12. Flexible hose according to claim 1, wherein the pressure support elements contact one another.

13. Flexible hose according to claim 1, wherein the pressure support elements cross one another.

14. Flexible hose according to claim 1, wherein the pressure support elements are woven together or interlaced.

15. Flexible hose according to claim 1, wherein the pressure support elements run in a spiral shape.

16. Flexible hose according to claim 1, wherein the pressure support elements comprise a textile yarn.

17. Flexible hose according to claim 1, wherein the pressure support elements comprise a plastic yarn.

18. Flexible hose according to claim 1, wherein the pressure support elements comprise a metallic wire.

19. Flexible hose according to claim 1, wherein the pressure support elements comprise a ceramic material.

20. Flexible hose according to claim 1, wherein the wall is constructed from several layers and the pressure support is arranged between two of the layers.

21. Flexible hose according to claim 1, wherein at least one layer of the wall comprises elastomeric material.

22. Flexible hose according to claim 1, wherein at least one layer of the wall comprises rubber.

23. Flexible hose according to claim 1, wherein the pressure support is arranged between two elastomeric layers.
